(19) United States
(12) Patent Application Publication
(10) Pub. No.: US 2017/0236133 A1
(43) Pub. Date: Aug. 17, 2017

(54) SYSTEM AND METHODS FOR LEAD GENERATION

(71) Applicant: Leadux GmbH, Berlin (DE)

(72) Inventor: Evgeny VINER, Berlin (DE)

(21) Appl. No.: 15/502,794

(22) PCT Filed: Aug. 9, 2015
(86) PCT No.: PCT/IL15/50809

§ 371 Date: Feb. 9, 2017

Related U.S. Application Data
(60) Provisional application No. 62/035,447, filed on Aug. 10, 2014.

(51) Int. Cl. G06Q 30/02; G06F 3/0487; H04L 12/58; G06F 17/30

(52) U.S. Cl. CPC G06Q 30/0201; G06F 17/30702; G06F 3/0487; H04L 51/04

(57) ABSTRACT

Systems and methods for producing, delivering, and managing leads, that automatically create lead collectors on arbitrary websites and independently of marketers are disclosed. The leads that are collected by the system from arbitrary websites can be sold to marketers which were not specified prior to the collection of the leads. The lead collectors are generated according to the design and content of a given website and the information known about the person currently viewing it.

### RELATED APPLICATION

This application claims the benefit of priority under 35 USC §119(e) of U.S. Provisional Patent Application No. 62/035,447 filed 10 Aug. 2014, the contents of which are incorporated herein by reference in their entirety.

### BACKGROUND OF THE INVENTION

The present invention in some embodiments thereof, relates to online marketing, and in particular to lead generation for online marketing.

Online marketing continues to grow. It is broadly used across almost all industry sectors and non-profit organizations. Known online marketing methods include display advertising, search engine advertising, published articles, and advertisements.

There are various pricing models for online advertising. These pricing models include CPL (cost-per-lead), CPC (cost per click), CPA (cost per action), and CPI (cost per impression). The cost-per-lead model requires the generation of leads. The term “leads,” as used here and throughout this document include personal information on an individual, which is collected on websites, via web pages of the web sites, and used by a marketer to contact the individual directly via telephone, email, text messaging, and other known forms of communication, both electronic and non-electronic.

The generation of leads is typically done directly by a marketer, using his own website or a website owned by a different person, with whom the marketer enters into a business relationship. In many cases the marketer is brokered to a website by a third party.

Generation of leads can also be done in the absence of the marketer. In this case, an entity, that specializes in one or more specific industry sectors, generates the leads, for example, through websites ad hoc for the collection of leads. These two lead generation methods are limited, both on the marketers' and the webmasters' sides.

From a marketer's standpoint, generating, administering and maintaining leads requires substantial effort. Marketers are often required to design their own lead collectors, enter into relationships directly with webmasters in order to put their advertisement on the webmasters' websites, use the services of a broker third party, such as, Google, or buy leads directly from third parties, who have created ad hoc websites for collecting leads.

From the webmaster side, interactions between the webmaster and a specific marketer prior to a lead being generated are required.

### SUMMARY OF THE INVENTION

According to an aspect of some embodiments of the present invention there is provided systems and methods for producing, delivering and managing leads using automatically generated lead collectors for, example, for non-predefined marketers.

Throughout this document “servers” include machines such as computers and computing or computer systems (for example, physically separate locations or devices), computer and computerized devices, processors, processing systems, computing cores (for example, shared devices), and similar systems, modules and combinations of the aforementioned. A “server” is typically a remote computer or remote computer system, or computer program therein, that is accessible over a communications medium, such as a communications network including the Internet, that provides services to other computer programs (and their users), in the same or other computers. A server may also include a virtual machine, a software based emulation of a computer.

Throughout this document, a “web site” is a related collection of World Wide Web (WWW) files that includes a beginning file or “web page” called a home page, and typically, additional files or “web pages.” The term “web site” is used collectively to include “web site” and “web page(s).”

Throughout this document, a uniform resource locator (URL) is the unique address for a file, such as a web site or a web page, that is accessible on Networks including the Internet.

Throughout this document, the element character “n” in the description herein and the drawing figures represents the last member of a series or sequence of elements, components, and the like.

Throughout this document, “leads,” include information about an individual, which is collected on websites, via web pages of the web sites, automatically, and used by a marketer to contact the individual directly via telephone, email, text messaging, and other known forms of communication, both electronic and non-electronic.

According to an aspect of some embodiments of the present invention there is a method executed by at least one server for automatically generating leads for information providing, over a network using at least one server, said at least one server including at least one processor in communication over a network with at least one web server, and with a storage device storing program code for implementation by the processor. The method comprises generating a lead collector having a user interface for collecting user inputs from a user at a web page of a web site hosted by a web server, the lead collector having at least one of a design and a media content selected based on an analysis of web page data automatically extracted from the web page, adding the lead collector to the web page at the web server so as to trigger the presentation of the user interface when the web page is presented by a browser executed on a client terminal; wherein the lead collector is adapted to obtain user inputs manually inputted by the user using a physical interface to the user interface when the browser presents the user interface, receiving the obtained user inputs at the at least one server from the client terminal or the web server, processing the obtained user inputs at the at least one server to generate at least one lead from the obtained data, and forwarding the at least one lead to an information provider.

Optionally, the web page data includes information selected from the group consisting of a textual content of the web page, a language of textual content of the web page, a hierarchical location of the webpage in the website, a theme of the web page, a design of the web page, links to web pages in the web page, and web sites linking to the web page.

More optionally, the web page data is obtained by a web page data collector integrated into a code of the website.

More optionally, the generating comprises identifying a profile of the user when the browser requests accessing the webpage; wherein the lead collector having at least one of a design and media content selected according to an analysis of the profile.

More optionally, the profile comprises a member of a group consisting of: an address of the client terminal, a domain of a server associate with the client terminal, an e-mail address of the user, at least one advertisement with which the user has been presented, an operating system (OS) of the client terminal, a Language of a keyboard of the client terminal, a Language of the OS of the client terminal, at least one keyword in a query submitted before the browser requests accessing the webpage, a content of the webpage currently highlighted based on a user input, an address of a previous webpage accessed before the browser requests accessing the webpage.

More optionally, the profile is obtained by a web page data collector integrated into a code of the website.

More optionally, the profile is obtained by monitoring previous data inputs of the user using the browser.

More optionally, the forwarding comprises additionally comprising calculating a score for the at least one lead for quality based on a match of at least one of the profile, the web page data, and the obtained user inputs and data defining the information provider.

More optionally, additionally comprising pricing the at least one lead based on the score.

Optionally, the user interface comprises an instant messaging (IM) interface for allowing the user to communicate with the information provider by inputting and receiving IM messages; wherein the forwarding the at least one lead to an information provider comprises adding an agent of the information provider to an IM session managed by the IM interface.

More optionally, the instant messaging is asynchronous instant messaging.

More optionally, the agent is a human agent.

More optionally, the agent is a computerized agent.

Optionally, the method further comprises: indexing, in a database, each web page of the web site hosted by the web server, according to an assigned index value; associating, in the database, each web page of the web site with at least one lead parameter including at least an advertising vertical category based on an analysis of data related to the web page; receiving, from at least one of the web server and the client terminal of the user accessing a certain web page of the website, a certain index value corresponding to the accessed certain web page; and accessing the database using the certain index value to retrieve the associated at least one lead parameter; wherein the generating the lead collector is performed according to the associated at least one parameter. Optionally, the method further comprises identifying the web pages by an automated network crawling program that crawls web pages of the web site. Optionally, the automated network crawling program repeats crawling of web pages of the web site to at least one of identify new web pages and identify new content on existing web pages. Optionally, the at least one lead parameter includes a member selected from the group consisting of: advertising vertical sub-category, a topic of discussion, and a content topic. Optionally, the at least one lead parameter is based on an analysis of a plurality of web pages associated with the web site. Optionally, the at least one lead parameter is includes a member selected from the group consisting of: a name of the business operating using the web site, a logo of the business operating using the web site, and colors of the business operating using the web site. Optionally, a different lead collector is generated for at least one of: each web page, a group of web pages of the web site, and different users accessing the same certain web page. Optionally, the lead collector is dynamically generated according to at least one of the user accessing the certain web page and content currently displayed on the web page.

Optionally, the method further comprises identifying the web server as a registered subscriber with the at least one server, and wherein forwarding the at least one lead to the information provider comprises forwarding the at least one lead to at least one of the web server, and a customer relationship management (CRM) system associated with the web server.

According to an aspect of some embodiments of the present invention there is provided a computer system for generating leads for information providing, over a network, comprising: an input interface for receiving from a lead collector, via a network, obtained user inputs from a client terminal or a web server; a program store storing code; and a processor coupled to the input interface, and to the program store for implementing the stored code, the code comprising: code to generate a lead collector having a user interface for collecting user inputs via a physical interface from a user at a web page of a web site hosted by a web server, the lead collector having at least one of a design and a media content selected based on an analysis of web page data automatically extracted from the web page; code to transmit the lead collector for adding to the web page at the web server so as to trigger the presentation of the user interface when the web page is presented by a browser executed on a client terminal;

wherein the lead collector is adapted for obtaining user inputs manually inputted by the user to the user interface when the browser presents the user interface; code to analyze the obtained user inputs to generate at least one lead from the obtained data; and code to forward the at least one lead to an information provider.

Optionally, the system comprises code to tag the at least one lead with at least one tag for identification of the at least one lead.

Optionally, the system comprises a code to score the at least one lead for quality based the on at least one tag of the at least one lead and code to price the at least one lead based on the score.

According to an aspect of some embodiments of the present invention there is provided a computer usable non-transitory storage medium having a computer program embodied thereon for causing a suitable programmed system to generate leads for information providing, by performing the following steps when such program is executed on the system, comprising: generating a lead collector having a user interface for collecting user inputs from a user at a web page of a web site hosted by a web server, the lead collector having at least one of a design and a media content selected based on an analysis of web page data automatically extracted from the web page;

adding the lead collector to the web page at the web server so as to trigger the presentation of the user interface when the web page is presented by a browser executed on a client terminal; obtaining user inputs manually inputted by the user to the user interface when the browser presents the user interface; receiving the obtained user inputs from the client terminal or the web server; processing the obtained user inputs to generate at least one lead from the obtained data; and forwarding the at least one lead to an information provider.

Optionally, the user interface for is a graphical user interface (GUI) having an instant messaging interface for facilitating the user to input chat messages while discussing with an agent of the information provider.

Optionally, the GUI is set to be presented over at least 50% of the web page.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1A is a diagram of an environment in which exemplary embodiments of the present invention are shown;

FIG. 1B is a diagram of the environment of FIG. 1A in which other exemplary embodiments of the present invention are shown;

FIGS. 1C and 1D are screen diagrams of the web page of FIG. 1B with different lead collectors;

FIGS. 2A and 2B are architectural diagrams of the data collection (FIG. 2A) and lead creation and processing (FIG. 2B) sides of central server/system of FIGS. 1A and 1B;

FIGS. 3A and 3B are a flow diagram of an exemplary process for obtaining data, including information, for leads, in accordance with embodiments of the present invention;

FIG. 4 is a flow diagram of an exemplary process for lead creation in accordance with embodiments of the present invention; and

FIG. 5 is a flow chart of a computerized method for generating lead collectors for web pages of a web site, in accordance with some embodiments of the present invention.

### DETAILED DESCRIPTION OF THE DRAWINGS

Embodiments of the present invention include systems and methods for producing, delivering and managing leads, which automatically create lead collectors on arbitrary websites, and, independently of marketers. The leads that are collected by the system from arbitrary websites may be sold to marketers which were not specified prior to the collection of the leads. The lead collectors are generated according to the design and content of a given website and the information known about the person currently viewing it.

Embodiments of the invention are also directed to the implementation of processes which analyze the design and the content of websites and the information known about the viewer, and create lead collectors according to this analysis and predefined elements, and manage the created leads and the customers in a database and a CRM (Customer Relationship Management) system.

Embodiments of the present invention provide websites with the option to incorporate lead collectors into it. This is achieved by a code, known hereinafter as a “web page data collector,” that the webmaster is offered to integrate in the website' s code. The web page data collector supports the lead collectors. The web page data collector links or maps to an intended destination, such as a remote central server, over a network, and the web page data collector submits information, for example, as data, to the remote central server. The information may include the website's content, the websites design, personal information about the person currently viewing the website, information on advertisements shown to the user, and services offered to him by others. The information is submitted to a remote and central server where it is saved and analyzed.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the

Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The systems and/or methods described herein may relate to the technical problem of providing a communication mechanism over a network connection between a user of a client terminal browsing a web page and a server. The communication mechanism provides the user with an interface to manually provide personal information to the server. The communication mechanism may be designed to associate the manually provided information with one or more advertised products.

The systems and/or methods described herein generate a lead collector, which is a new data structure, optionally a data object, having executable code, for example, a script, self-executing compiled code, instructions for rendering by the browser, instructions for execution by the web server, and/or other instructions. The lead collector interacts with a user through a physical interface, allowing the user to manually enter information into the lead collector, for example, by typing the data into the lead collector, by pressing a touch screen to enter the data, and/or by audio recordings which are stored by the lead collector.

The systems and/or methods described herein may improve performance of the client terminal, the web server, and/or the communication network, for example, in terms of processing resources, network resources (e.g., bandwidth), and/or storage requirements. The improvement in performance may be achieved by designing the lead collector according to the web page and/or user, rather than, for example, providing a generic lead collector for all web pages and/or all users. The generated lead collector may be better adapted to the available resources in the current environment, which may use fewer resources than a generic lead collector which is not generated according to the current environment.

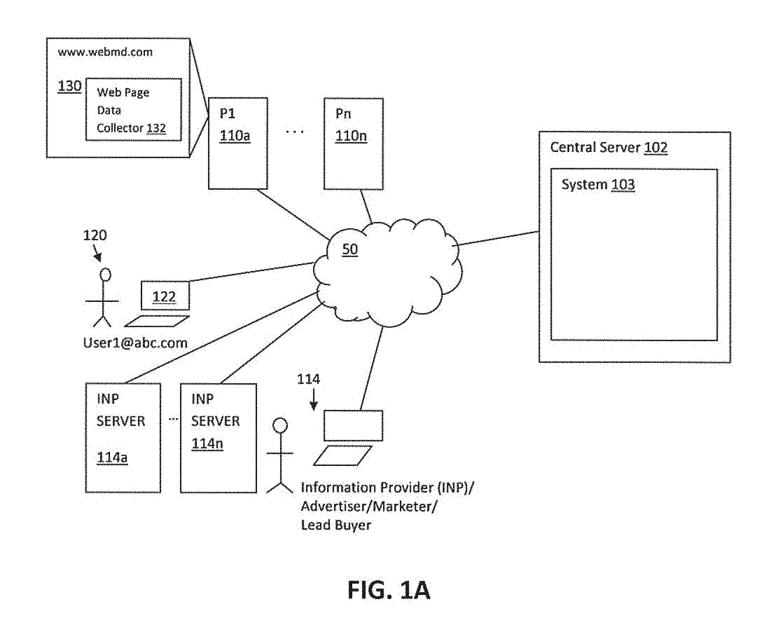

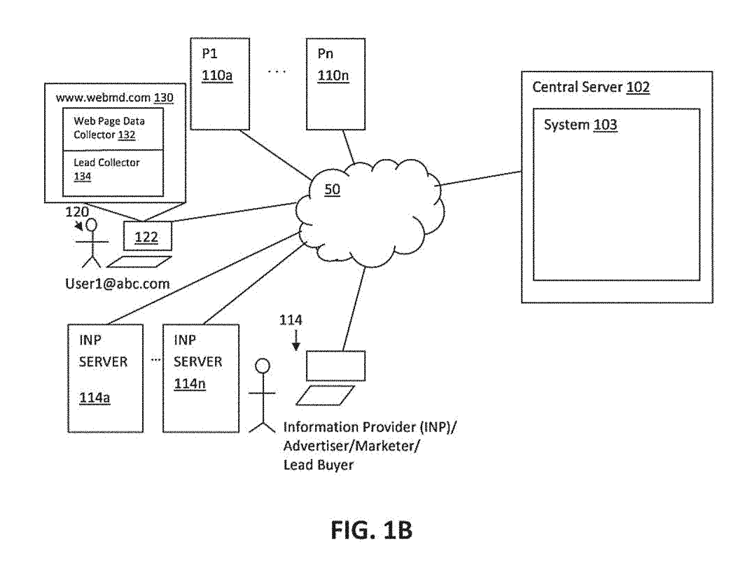

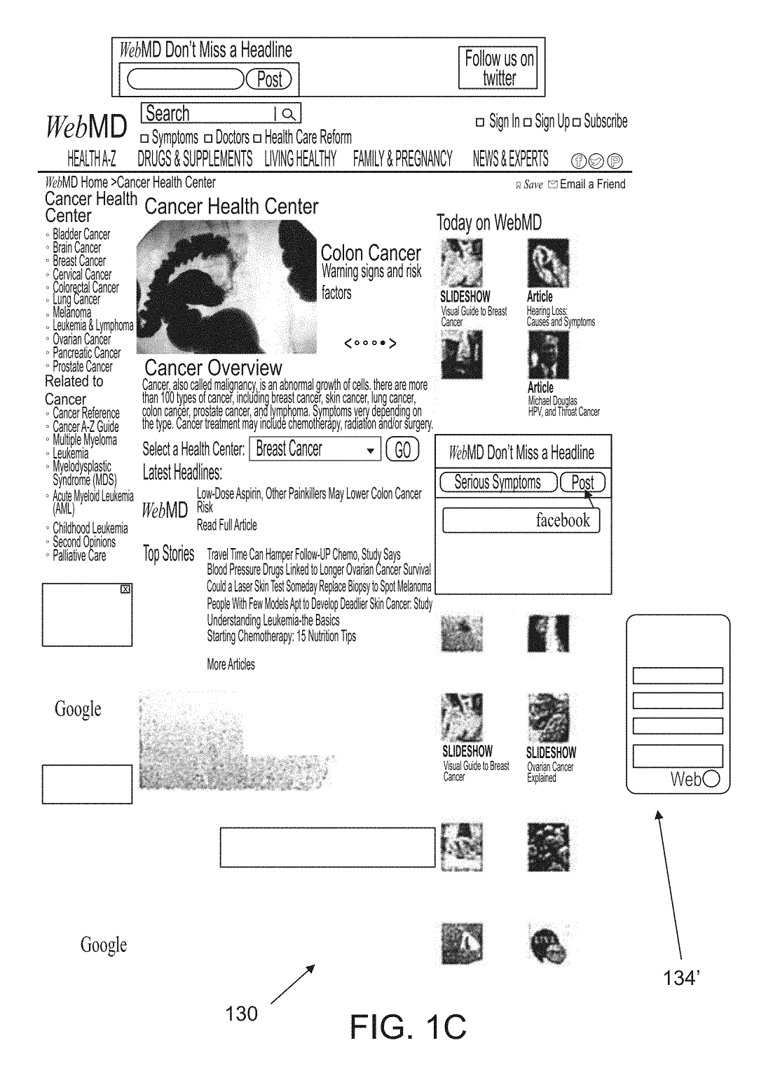

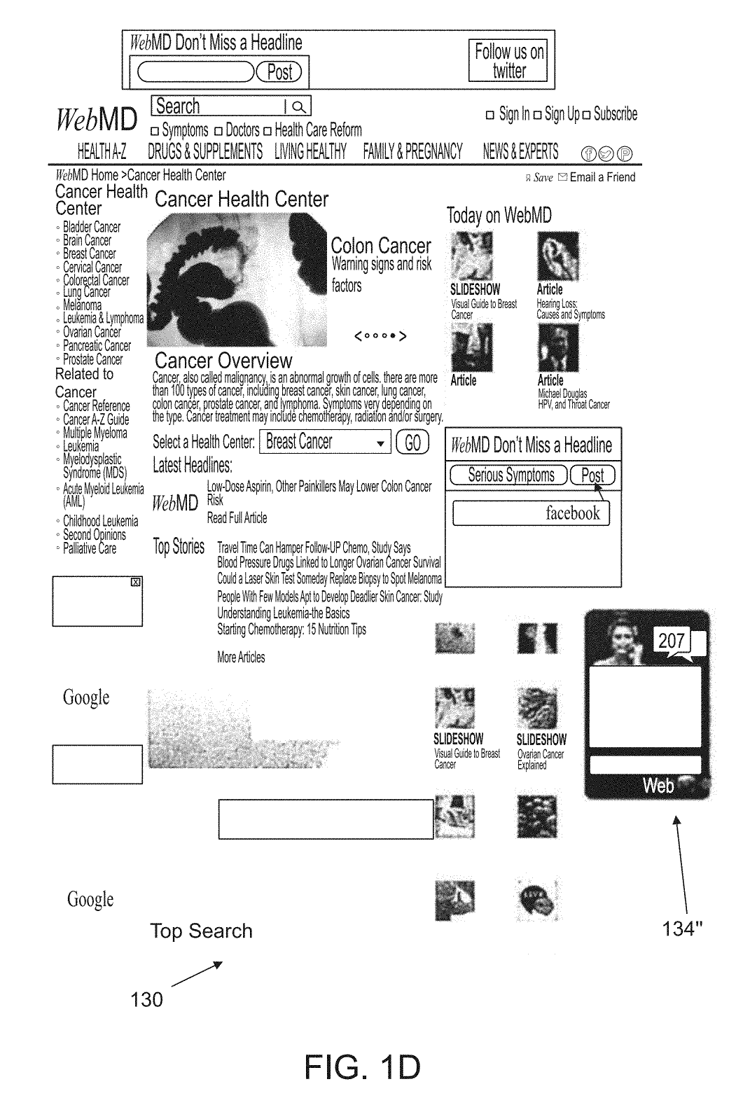

Reference is now made to FIG. 1A, which shows an operating environment for a central server 102, also known as a main server. The server 102 defines a system 103 for lead generation, lead collection, lead management, and lead administration, in accordance with some embodiments of the present invention.

The server 102 includes hardware, software and combinations thereof in order to perform embodiments of the present invention. The server 102, while shown as a single server, may be a computer system and formed of multiple servers, devices, components, modules, and the like.

The server 102, and the system 103 executed thereon, generate lead collectors.

The generation of these lead collectors is, for example, a dynamic process, as the lead collectors are generated based on web page data received from a web page data collector 132, which is integrated or embedded into the code of the web site, which includes the web page, as detailed below. Throughout this document, “web page data” is any data associated with the web page and/or user(s) whose browsing applications currently access the web page, as indicated by the web page data collector 132 and received by the system 103 of the server 102 from the web server of the web page or from the browser who runs the code of the webpage. For example, the web page data may include data extracted from an analysis of the web page such as a textual content of the web page, a language of textual content of the web page, a hierarchical location of the webpage in the website of the webpage, a theme of the web page, a design of the web page, links to web pages in the web page, and web sites linking to the web page.

Additionally or alternatively, the web page data includes one or more profiles of the users who access the webpage, for example targeted users who are about to pre presented with a user interface of the lead collector. The profile may include an address of the client terminal of the user, a domain of a server associate with the client terminal, an e-mail address of the user, at least one advertisement with which the user has been presented, an operating system (OS) of the client terminal, a Language of a keyboard of the client terminal, a Language of the OS of the client terminal, at least one keyword in a query submitted before the browser requests accessing the webpage, a content of the webpage currently highlighted based on a user input, an address of a previous webpage accessed before the browser requests accessing the webpage. The web page data, which has been extracted, is received by the server 102, where it is analyzed. From an analysis of the web page data, the system 103 selects a lead collector, and sends the selected lead collector to the web page.

Optionally, the web page data is related to resources available for transmitting and/or displaying the generated lead collector, by the web server and/or the client terminal. Examples of web page data related to available resources include: available processing resources, available memory and/or storage resources, screen size of the client terminal, bandwidth of the connection between the client terminal and the web server, and web server load due to other users. The available resource may be analyzed and taken into account when generating the lead collector. For example, a different lead collector may be generated for the same website, for a user using a powerful desktop computer with a high bandwidth internet connection, and for a user using a Smartphone running multiple concurrent applications using a wireless connection with poor connectivity. In the first case, a lead collector using animation of images may be generated (i.e., large storage size, requiring significant bandwidth and/or processing resources), while in the second case, a simpler lead collector using simple graphics may be generated (i.e., small storage size, requiring limited bandwidth and/or processing resources).

The web page data may be data extracted from the web page itself, either at the web server hosting the web page, by a crawler, or by the lead collector, for example when the lead collector code is executed by a browsing client terminal.

Additionally or alternatively, as described above, when a user is browsing the web page, the web page data may be data about the user obtained by the web page data collector.

The server 102, and its system 103, uses algorithms to analyze the web page data, which is extracted, to generate the lead collectors. For example, the design of the lead collectors may be based on the design of the web page, from which the web page data was obtained, and/or design elements from a pool of predefined elements that are available on the server 102, and which may be algorithmically associated with the collected web page data.

The content of the lead collectors may also be created from the obtained web page data. For example, the content may be the actual content of the webpage/website, or portions thereof, and any related or associated content, or other features of the web page/website. The content may also include information on the vertical of the lead collectors, e.g., based on keywords of the website. Content may include questions that are meant to attract the user to the lead collector; to obtain the user's input, including entering his personal information in the lead collector. Content may be simple, hereby only representing the lead collector's vertical and asking the user to leave his personal information in it, or interactive, hereby obtaining additional information about the user.

In case of interactive lead collectors, the design may change according to any new information acquired by the system 103. This new information includes data that was extracted from any new web page data, sent to the system 102, after having been acquired from the web page data collector 132.

The lead collectors include instructions to present a graphical user interface (GUI) when the webpage is rendered by a browser. The GUI may include interactive objects for allowing a user who browses the respective webpage. The GUI of the lead collector interacts with a user through a physical interface (e.g., keyboard, mouse, touch-screen, microphone), allowing the user to manually enter information into the lead collector, for example, by typing the data using a keyboard, by pressing a touch screen to enter the data, and/or by audio recorded using a microphone which is received by the lead collector.

The placement may be such that the interactive object is within or partly within the actual web page, or located just outside of, or bordering the actual web page. Exemplary lead collectors may be interactive objects, which require the user to manually input text, graphics, audio or video, and the like, into designated locations in the interactive object. Other exemplary lead collectors may be interactive objects such as chat requests, which require a user to activate or pointer (e.g., mouse) “click” on a designated location of the interactive object, to initiate a chat or other audio communication with a manual or automatic agent at the mapped destination of the interactive object. For example, the user interface comprises an instant messaging (IM) interface for allowing the user to communicate with the information provider by inputting and receiving TM messages, for example providing an instant messaging (IM) service editor that allows the user who is presented with the lead collector to communicate with an agent of the information provider. The agent may be a computerized agent, such as a natural language processing (NLP) agent, which is set to analyze the user inputs and to promote a sale or data distribution based thereupon. The agent may be a human representative of the information provider. Optionally, the IM is asynchronous and may be continued in a latter visit of the user in the webpage and/or in other webpages which present the user interface of the generated lead collector. Optionally, the IM is synchronous and restarted every visit of the user in the webpage and/or in other webpages which present the user interface of the generated lead collector.

The lead collectors are used to collect data from the users via the web pages, to which the user's browsers are directed. The data from the lead collectors, alone or coupled with web page data obtained by the web page data collectors, is used to generate leads. The system 103 classifies, categorizes and sorts the leads, making the leads available for purchase. Additionally, the system 103 communicates with information providers, advertisers, lead buyers and other entities, over the network 50, and as such may select and forward, e.g., transmit or send selected leads to selected information providers, advertisers, lead buyers and other entities.

Publisher servers 110a-110n are linked to the network 50. These publisher servers 110a-110n host various web sites, formed of web pages. For example, the server 110a of Publisher 1 (P1) hosts a web site for the publisher webmd, with a URL of www(dot)webmd(dot)com. The web site includes the exemplary web page 130, which includes a web page data collector 132. The web page data collector 132 integrates or embeds into the code of the web site, by numerous methods, including injection and the like.

The web page data collector 132 includes an application programming interface (API), which links to the lead collector 134, which has been rendered to the web page/web site. The API links or maps to the system 103 of the central server 102 or other mapped destination over the network 50. This linking or mapping allows for the web page data, obtained by the web page data collector 132, and/or the data obtained by the lead collector 134 to be collected and stored, so as to be used in creating leads. The web page data collector 132 may include a function call, for passing obtained data to the server 102 over the network 50, or any other linked or mapped destination.

The web page data collector 132 is designed to display the generated lead collectors 134 on the web page(s) of the website.

The web page data collector 132, as integrated into the web page/website, is capable of dimming areas of the web page/website in order to focus the viewer on the lead collector 134. The web page data collector 132 can follow the user to other pages of the website. For example, even when the lead collector 134, e.g., the GUI thereof, is in its half-filled state, this GUI transfers to the new web page in its present state, e.g., half-filled, allowing the user to complete the filling of missing data. The web page data collector 132 may submit the user's data, which is used in creating leads. The web page data collector 132 may also create an interactive session between the lead collector 134 and the user, and provide further data for collection by the system 103.

The web page data collector 132 may be programmed to include prompts and questions for the user to enter data, including personal information. The prompts and questions may be simple, asking the user to enter personal information in it. Alternately, the prompts and questions may be interactive, based on a user response to a previous prompt or question. The web page data collector 132 may be such that the design of the web page, the prompts or the questions, may be cumulative, changing according to the new information (attributes) obtained from the user. In this interactive case, the web page data collector 132 may perform a semantic analysis of the user entered data to provide further prompts or questions for the user, to obtain further data.

The web page data collector 132 monitors the web page 130 for submissions to the lead collectors 134, from users. The web page data collector 132 performs the monitoring by determining when the user's browsing application is open and directed to the web page 130 that includes the lead collector 134. The submission may start from the first letter entered by the viewer into the lead collector 134 of the web page 130. By the web page data collectors 132 monitoring the browser, coupled with the lead collectors 134 collecting data from the open browser, leads are kept regardless of the status of the browser, including crashes thereof and problems with internet connectivity.

The submission of the data via the lead collector 134 continues throughout the entire time in which the user's browser is open, and, for example, directed to a web page, including when redirected to another web page. Additionally, the web site data collector 132 may be such that it can provide text, graphics, video and audio onto the web page to attract users to the lead collectors of the web page once their browser is directed to the web page for lead collection.

Information provider (INP) servers 114a-114n are associated with information providers 114. These servers 114a-114n are linked to the network 50, either directly or indirectly. The information providers 114, include, for examples, parties who acquire or purchase leads from the system 103. Examples of information providers, and others who purchase leads from the system 103 include, advertisers, marketers, web site promoters, lead buyers and the like. These aforementioned entities are collectively referred to hereinafter as “information providers,” indicated by element 114 if FIGS. 1A and 1B, or lead buyers, with these terms being used interchangeably herein, and in some instances, together herein.

A user 120 (user1, with the e-mail address user1 @abc(dot)com), via his computer 122, which includes a browsing application or browser, such as Internet Explorer® from Microsoft, or Chrome®, from Google®, or Firefox®, from Mozilla, is linked to the network 50, either directly or indirectly. The user 120 is representative of multiple users linked to the network 50.

When the user 120 directs the browsing application of his computer 122 to the web page 130, and this is detected by the system 103. The system 103 responds by generating and sending a lead collector for placement in the web page 130, as shown in FIG. 1B.

Additionally, the web page data collector 132 may now obtain web page data about the user, and send it to the system 103 for analysis and extraction. This web page data about the user, either alone, or coupled with web page data obtained about the actual web page, may be used to generate a lead collector. This lead collector is then sent to the web page 130 for placement therein.

Turning also to FIGS. 1C and 1D, the lead collector 134 on the web page may be a GUI (graphical user interface), which is an interactive object. The interactive object links or maps to the central server 102, or other intended destination, typically over the network 50. In FIG. 1C, the lead collector is a GUI 134′, for receiving manually entered input from a user. In FIG. 1D, the lead collector is a GUI 134″, which is a chat request.

When the GUI 134″ is activated, a chat session begins between the user 120 and an agent, associated with the central server 102 (or other intended destination), from which information for the leads is collected.

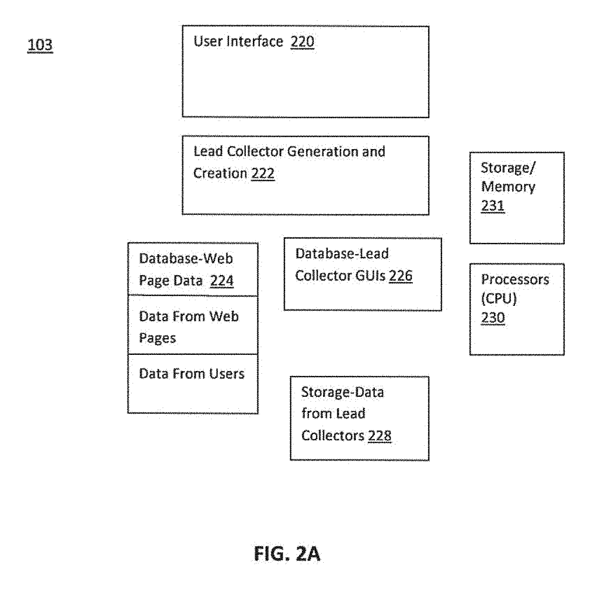

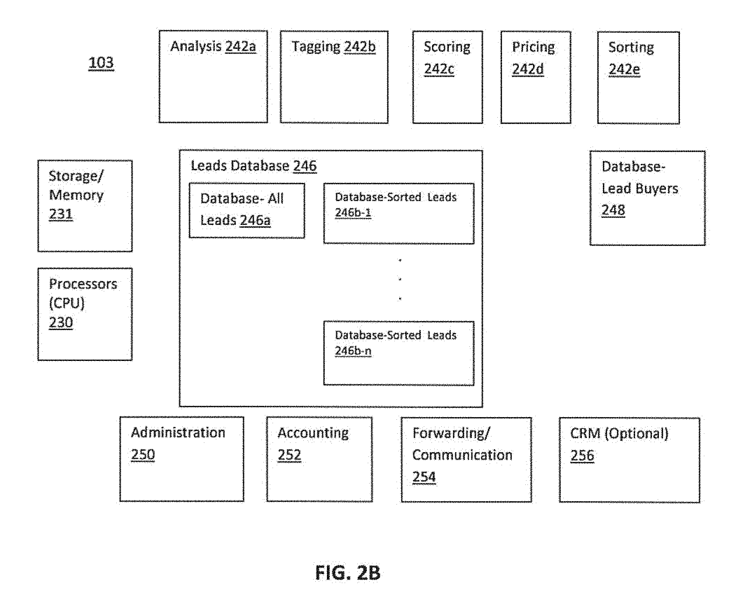

FIGS. 2A and 2B, to which attention is now directed, show the architecture of the system 103 of the main server 102. FIG. 2A details the components associated with data collection from the lead collectors 134 and the web page data collectors 132, while FIG. 2B details components for processing, maintaining, and administering the leads, obtained from the data collected from the lead collectors 134 and web page data collected by and obtained from the web page data collectors 132.

Turning to FIG. 2A, the system 103 includes a user interface module 220. This module 220, allows for publisher, user, and information provider, input to and output from the system 103. The user interface module 220 functions to maintain data flow between the system 103 and one or more of: users, such as users 120, information providers 114, who purchase or otherwise obtain the leads from the system 103, and publishers P1-Pn.

The user interface module 220 has an interface for webmasters, in which they can inspect information on leads that were created on their websites. Information can include the number of collected/sold leads, the price for which lead were sold, the webmaster's share of the profits, the closest pay date, and the like.

The lead collector generation module 222 creates the lead collectors for placement in or proximate to web pages. This module 222 is configured for analyzing extracted web page data, either obtained dynamically, or stored in a database 224, or combinations thereof. This module 222 also includes and runs algorithms for the design and content of the lead collectors. The module 222 also includes algorithms for sending the generated lead collector to the web page 130, over the network 50, for placement in the web page. Additionally, the module 222, when designing the lead collectors may obtain a GUI for the lead collector, from the GUI database 226.

The lead collector generation module 222 designs the lead collectors, which may be based on attributes such as the design and content of the webpage or website, to which the browser of the user's computer 122 is directed. The design may also include, for example, design elements from a pool of predefined elements that are available on the server 102 and can be algorithmically associated with the data collected from the user. The content may be the actual content of the webpage/website, or portions thereof, and any related or associated content, or other features of the web page/website. The content may also include information on the vertical of the lead collectors, e.g. based on keywords of the website. The content may include questions that are meant to attract the user to the lead collector; to obtain the user's input, including entering his personal information in the lead collector. Content may be simple, hereby only representing the lead collector's vertical and asking the user to leave his personal information in it, or interactive, hereby obtaining additional information about the user.

In case of interactive lead collectors, the design may change according to any new information acquired by the system 103 from and/or about the user.

There is also a storage medium or unit 228, which receives all of the information, e.g., in the form of data, received from the lead collectors 134 and the web page data collectors 132′.

The processors 230 control the operation of the components of the system 103. The processors 230 are conventional processors, such as those used in servers, computers, and other computerized devices. The processors 230 may be arranged to have a central processing unit (CPU), for controlling the system 103 and all components associated therewith. For example, the processors 230 may include x86 Processors from AMD and Intel, Xenon® and Pentium® processors from Intel.

The storage/memory 231 is any conventional storage media. The storage/memory 231 stores machine executable instructions associated with the operation of the modules 220, 222, 242a-242e, 250, 252, 254, 256. Also, the storage/memory 231, although shown as a single component for representative purposes, may be multiple components, and may be outboard from the system 103, and linked to the network 50.

Turning to FIG. 2B, the analysis module 242a functions to analyze data obtained from the lead collectors 134 and the web page data collectors 132, which is, for example, stored in the database 228 (FIG. 2A). The analysis module 242a generates leads from this collected and otherwise obtained data, and stores all generated leads in database 246a, of the database 246. The analysis may be performed in real time, with the performance being continuous and cumulative, or after a requisite amount of data has been collected, and optionally, thereafter continuous and cumulative.

Tagging module 242b or tagging device functions to tag leads with information specific to the lead. These tags typically serve as identifiers for the leads, and are useful, for example, when sorting the leads. The leads are tagged for association with information, i.e., web page data, already known about the web site and the user, from which the lead was collected. Each lead may receive tags, for example, for geography, language, website address and full page address, exact time when the lead was captured, technological data (device, network), search term the user entered to get on the website, page analysis (the relevant vertical), information from the internet the system can collect based on the viewer information (e.g., search of his email address), and, quality of the lead (based of analysis of the information and a scoring system).

A scoring module or scorer 242c functions to implement a scoring algorithm, that assesses the quality of the lead according to the information tagged. The quality of the lead is used for pricing purposes. The leads are priced by a pricing module or pricer 242d, based on their quality, represented by a score.

A sorting module or sorter 242e functions to sort the leads based on one or more of their tags. For example, leads may be sorted into various databases 246a to 246n, as those for specific information providers 114 (lead buyers), and in lead pools. The lead pools may be bidding pools, where the leads are sorted into one or more bidding pools, for example, based on their relevant vertical. Information providers 114 (lead buyers) may bid for the leads and the leads will be sold to the highest bidder(s). Another example lead pool is a normal lead pool, from which the leads may be sold to one or more information providers (lead buyers).

The system 103 is also associated with search engines, which are accessed over the network 50. For example, the use of information about each user, from whom a lead was obtained, may be used in acquiring further information about that user. As an example, an e-mail address of a user may be used to search for information about the user on social networks, such as Facebook, Linkedin, Odnoklassniki, Vkontakte. This user information, as well as the additional user information may be tagged and stored in the database 224 (the Data From Users portion). Tags, for example, for the aforementioned user information may be for birthday, country, city, marital status, place of work, education, and the like.

The leads databases 246 are conventional storage media, and are arranged for storing leads. There is a common database 246a for all leads, along with other databases 246b-1 to 246b-n for groups of categorized leads, of which new databases may be created for a newly created categorization or classification of leads.

Database 248 stores data associated with lead buyers who have purchased leads. The stored data includes, for example, the name of the lead buyer, the actual leads purchased, and the price at which the leads were purchased, and other data associated therewith.

Databases 246, 248 may be single or multiple components. The databases 246, 248 may be either within the server 102 or outside of the server 102, or linked to the server 102 either directly or over the network 50.

An administration module 250 performs the administrative functions of the system 103, including handling lead buyer bids for leads, including auctions. This module also handles lead purchases, including information providers 114 (lead buyers) purchasing leads on a prepaid basis, for example, methods such as PayPal®, wire transfers, online currencies, and the like. The module 250 may also provide an automatic system, allowing for information providers 114 (lead buyers) to purchase predefined amounts of leads at a predefined price, and/or of a predefined quality, from the system 103.

An accounting module 252 controls lead buyer accounts, concerning lead purchases from the system 103.

A forwarding or communications module 254, which may also be a transmitter, forwards, sends, transmits, or otherwise communicates leads to various information providers 114.

An optional CRM (Customer Relationship Management) module 256 administers and manages leads with information providers 114 (lead buyers), for example, by managing and delivering leads for information providers 114 (lead buyers) who have accounts with the system 103. The management and delivery of the leads is performed, for example, by the CRM module 256, as it allows information providers 114 (lead buyers/marketers) to create user accounts in the system 103, along with the administration 250 and accounting modules 252 of the system, to offer full control over handling of the leads and maintaining the statistics for these leads. The CRM module may also analyze leads, which may be best suited for certain information providers 114.

Additionally, for example, the CRM Module 256 may suggest bids for an information provider 114 in order to obtain leads which are determined to be best suited for the information provider 114.

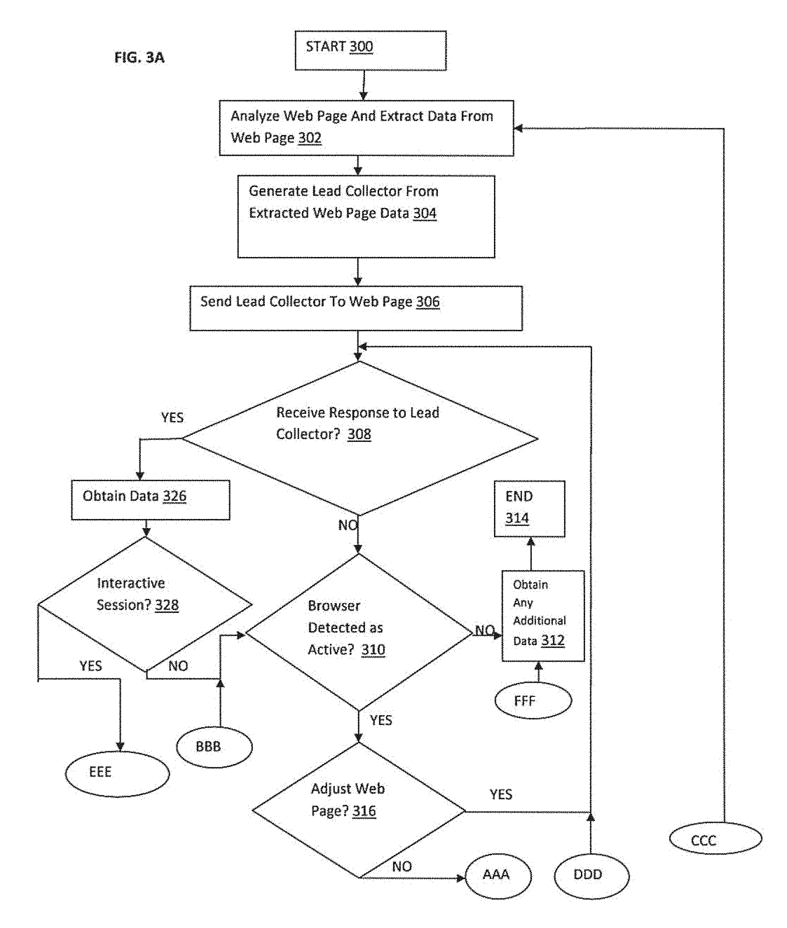

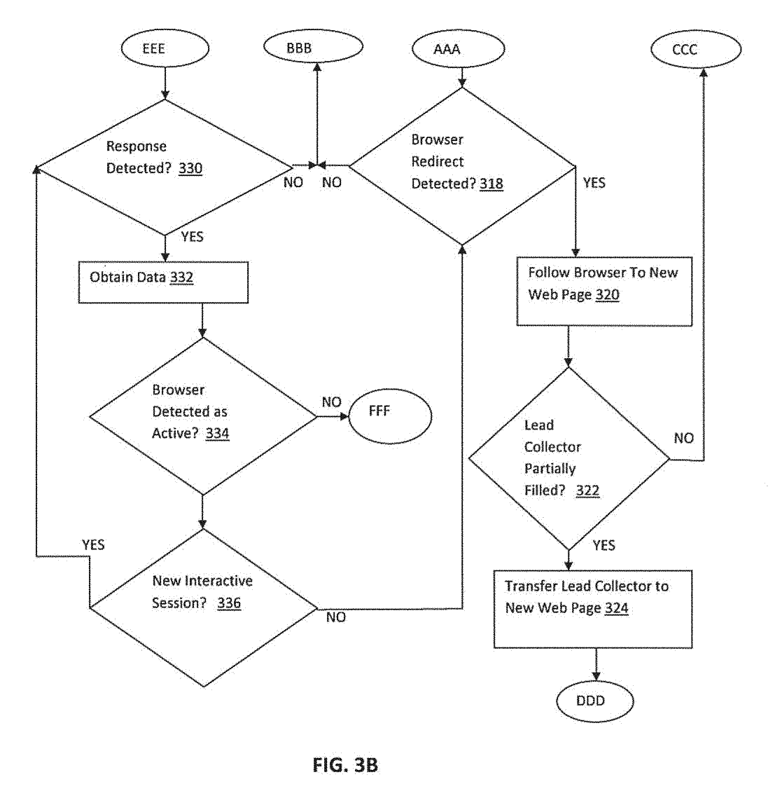

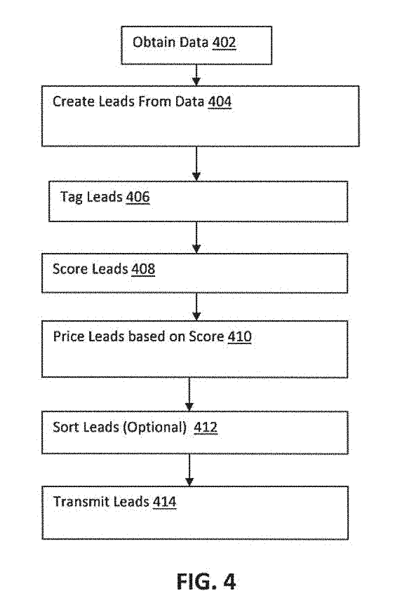

Attention is now directed to FIGS. 3A, 3B, and 4, which are flow diagrams detailing processes in accordance with embodiments of the disclosed subject matter.

Reference is also made to elements shown in FIGS. 1A, 1B, 2A and 2B. The process and subprocesses of FIGS. 3A and 3B are computerized processes performed by the system 103 with respect to the web page data collectors 132 and the lead collectors 134, in accordance with embodiments of the disclosed subject matter. The web page data collectors 132 and the lead collectors 134 are operative at the web page of the web site in which the user's browser is directed to, in order to collect data about a user 120, to whose computer 122 the web page/web site has been rendered. One or more leads are and ultimately generated from the collected data. The process and subprocesses of FIG. 4 are computerized processes performed by the system 103 to analyze the data collected about and/or obtained from the user, and generate leads, which are subsequently identified and classified. The processes and subprocesses of the aforementioned flow diagrams are, for example, performed automatically and in real time.

Turning to the flow diagram of FIGS. 3A and 3B, the process of obtaining data for generating leads is shown. While the process is described for a single lead collector, the process is similar should multiple lead collectors be desired.

The methods of FIGS. 3A, 3B, 4 and 5 may be implemented by processor 230 of system 103 implementing code stored in program store of storage 231.

The process begins at the START block 300. At this START block 300, the web page data collector is integrated or embedded into the code of the web site, which includes the web page. This insertion or embedding of the web page data collector, as well as any additional web page data collectors, may be manual or automatic.

For example, manual integrations of web page data collectors may be performed by the webmaster of the website, of which the web page is part of, by actually reprogramming the code of the web site. For example, automatic integrations include web page data collectors, such as advertisements in the form of banners, scrolls and the like, returned to a web site and injected into a code of the web site upon receipt at the web site. The system sends the ads in response to an advertisement request, upon receiving the advertisement request.

The process as shown at block 302 is such that the web page is analyzed and data is extracted from the web page by the web page data collector. The extracted data is sent to, and received, by the system 103. The system 102, for example, the lead collector generation module 222 analyzes the extracted data and generates a lead collector from this extracted data, at block 304. Additional data, for example, such as the data stored in the database 224, may also be used in the lead collector generation process, along with the lead collector generation algorithms (also stored, for example, in the lead collector generator module 222), such as the algorithms discussed above.

When a user's browser is detected as directed to the web page with the web page data collector, as shown at block 306, the now created lead collector is sent to the web page being browsed, for placement into the web page. Alternately, prior to the performance of the step of block 306, the steps of blocks 302 and 304 may be performed using web page data from both the web page itself and the user to create the lead collector, as detailed above.

The web page data collector displays each lead collector on the web page.

As shown in to block 308, it is determined whether the system 302′ received a response to the lead collector. When a response is not received, as shown in block 310, it is determined whether the browser of the user is active or open, and directed to the web page. Should the browser no longer be active, as shown in block 312, any additional web page data is obtained by the web page data collector, and any additional data from the lead collector of the web page, which is received by the server 102, is stored in the data storage unit 228 of the system 103. The end of the process is shown at block 314.

Returning to block 310, should the web page data collector detect the browser as active and open, whereby the browser is directed to the web page, as shown in block 316. At block 316, the web page data collector determines whether to adjust the web page. This adjustment includes, for example, a portion of the web page dimmed, by the web page data collector, to attract the user to the lead collector, from which data is obtained about the user. Should a web page adjustment be made, the steps of the process resume from block 308.

However, should a web page adjustment not be made, the steps shown in block 318, are performed, where the system 103 determines whether a browser redirect, to a new web page within the web site, has been detected, by the system 103. Should a browser redirect not have been detected, steps are performed from block 310.

Otherwise, should a browser redirect have been detected, the as shown in block 320, the system 103 follows the browser to the new web page of the web site. As shown in block 322, the system 103 determines whether the lead collector is partially filled or completed, Should the lead collector be partially filled or completed, the lead collector is be transferred to the new web page, and the steps of the process resume from block 308. From block 320, the steps of the process resume from block 302.

Returning to block 308, should a response to the lead collector be received by the system 103, the web page data collector and data collector and lead collector obtain data from and about the user, at block 326. This obtained data includes data submitted or otherwise inputted into the lead collector 134, by the user, which is sent by the web page data collector 132 over the network 50 and received by the system 103, which stores this obtained data, for example, in the storage unit 228. The submission may start from the first letter entered by the viewer into the lead collector 134 of the web page 130, which contains the web page data collector 132 and the lead collector 134. By monitoring the browser and collecting data from the open browser, leads are kept regardless of the status of the browser, including crashes thereof and problems with internet connectivity. The submission of the data via the lead collector 134 continues throughout the entire time in which the user's browser is open, and for example, directed to the web page.

The steps of the process are now shown from block 328. At block 328, the system 103 may then present an interactive session, as a further interactive object, to the user.

Should an interactive session not be presented to the user, at block 328, the steps shown in block 310 are performed. However, should an interactive session be presented to the user, at block 328, the steps of block 330, are performed, including the step of determining if the system 103 has detected a response to the interactive session.

Should the system 103 not have detected a response, at block 330, the steps beginning at block 310 are resumed. However, should the system 103 have detected a response, at block 330, the steps are performed from block 332.

At block 332, the web page data collector and lead collector obtain data from and about the user. This obtained data includes data entered or otherwise inputted into the lead collector by the user. This data is sent by the web page data collector over the network 50 and received by the system 103, which stores this obtained data, in the storage 228.

From block 332, the step of block 334 is now performed, where it is determined whether the browser is active and open, and directed to the requisite web site. Should this not be the case, the step of block 312 is carried out, and block 316 is the end of the process. However, should the browser remain active and open, and directed to the requisite web page, the step of clock block 336 is performed.

At block 336, the system 103, via the lead data collector determines whether a new interactive session will be presented to the user. Should a new interactive session be presented, the steps of the process are performed from block 330. Otherwise, the steps of the process are performed from block 318.

Attention is now directed to the Flow Diagram of FIG. 4, where the obtained data is formed into leads, according to some embodiments of the present invention. The process begins at the step of block 402, where the data obtained from the user, via the lead collector(s) and web page data collector 132, is acquired from the storage unit 228 of the system 103.

At block 404, the analysis module 242a applies an algorithm to the data to create one or more leads from the data. The leads are then stored in a database for all leads 246a.

Subsequently, at block 406, the leads are tagged. The tagging is performed by the tagging module 232b, with the tags associated with information already known about the user and the website, e.g., the web page data, from which the user data was obtained. The tagging may include placing tags on the leads, for identifying the leads.

The tags may include tags for geography, language, website address and full page address, exact time when the lead was captured, technological data (device, network), search term the user entered to get on the website, page analysis (the relevant vertical), information from the internet the system can collect based on the viewer information (e.g., search of his email address), and, quality of the lead (based of analysis of the information and a scoring system).

Subsequently, at block 408, the leads are scored by a scoring module 242d of the system 103. The scoring module 242d and scoring process operate by assigning a score to each lead based on the quality of the lead according to the information of the lead which is tagged.

As shown at block 410, the pricing module 242e prices the leads based on their score, indicative of the quality of the lead.

The leads may then be sorted in an optional sorting step, at block 412. The sorting is such that the leads may duplicated so as to be associated with one or more information providers 114 (lead buyers) and/or lead pools. The sorting may be, for example, based on the relevant verticals, so as to be available in multiple instances for information providers 114(lead buyers).

As shown in block 414, selected leads, for example, those associated with a particular information provider 114 (lead buyer), may be transmitted, such as by being forwarded, sent, or otherwise communicated, to the particular information provider 114 (lead buyer), by the forwarding/communication module 256. For example, the forwarding/communication module 256 may be programmed to select the leads from the database 246a-246n, from which leads are sorted for a particular information provider 114 (lead buyer), and forward these leads to the information provider 114 (lead buyer), for example, over the network 50.

The leads may be imported by information providers 114 (lead buyers) as a CSV (Comma Separated Value) file to the information providers 114 (lead buyers) own CRM. The CSV file including the desired leads may be packaged into the CSV file, and the transmitted in the CSV file to the information providers 114 (lead buyers) CRM, by the forwarding/communication module 254. Additionally, leads can be transmitted to all major CRM systems (e.g. Microsoft Dynamics, Salesforce, Zoho, etc.), by numerous conventional transmission means.

Optionally, the information provider receiving the leads may be a registered member and/or user of a lead providing service. The information provider may be the same entity, or an entity related to the web site from which the leads were obtained via the lead collector, for example, the information provider may be an online store, an advertiser, a marketer, and/or other service provider. The leads may be obtained, for example, from the web site of the store, and/or from another website associated with the store, for example, a blog discussing new products that the store offered, which is operated by the store owner. In such a case, the leads collected from the web pages of the registered member may be designated for exclusive use by the same registered member, for example, the leads may belong to the registered member and/or not sold or distributed to other information providers. For example, the registered member may receive the lead collection and distribution service as a software as a service (SaaS), for example, for a flat monthly rate regardless of the number of leads the registered member receives. The leads may be provided to a CRM of the registered member via a network link with the server. The registered member may use the user interface associated with the server to track the generated leads, for example, to track conversions from traffic of campaigns in search engines.

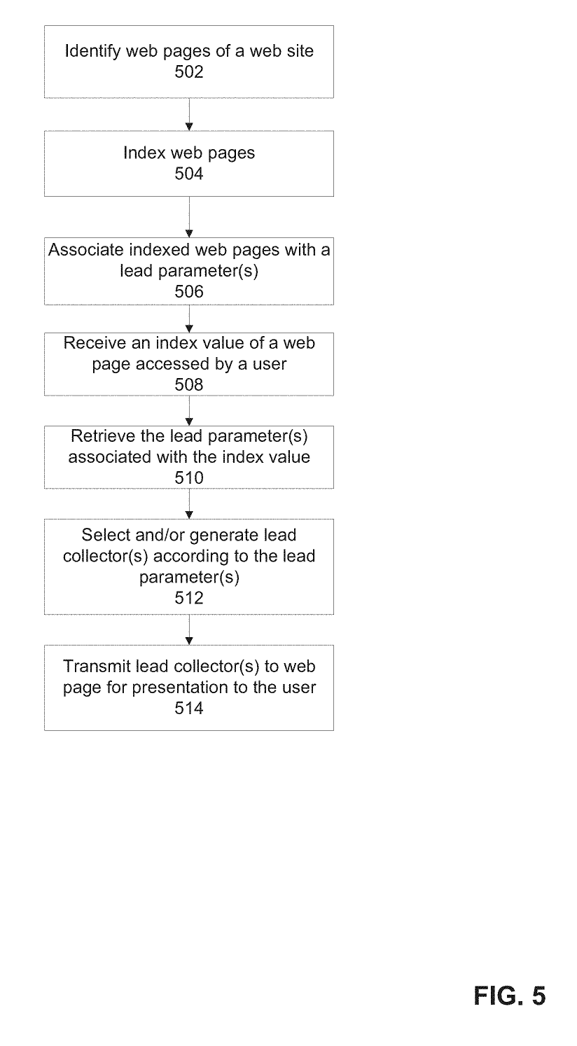

Reference is now made to FIG. 5, which is a flowchart of a computerized method for generating lead collectors for web pages of a web site, in accordance with some embodiments of the present invention. The method may pre-process the web pages of the web site (i.e., before the pages are accessed by the user), to generate a database of indexed web sites and associated lead parameter(s). The indexing allows for dynamic selection and/or dynamic generation of lead collectors for the web page being accessed by a user, according to the associated lead parameter. The method may improve performance of the web page, server, network, and/or client terminal, by performing the web page analysis in advance, and selecting and/or generating the lead collector in real-time when the user browses the web page.

The method may allow for different lead collectors to be presented on different web pages of the same web site. Different lead collectors may be presented for different individual web pages, or for different groups of web pages (i.e. the same lead collector is presented for web page members of the group). In this manner, lead collectors may be better matched to the web page and/or web site.

The method may allow for lead collectors to be generated according to an analysis of a group of web pages, and/or of the whole web site, for example, rather than on a page by page basis. The group and/or whole analysis may allow for generation of lead collectors that are better matched, for example, to a business operating the website.

For example, the generated lead collector may include the name of the business, the logo of the business, and/or colors of the business, which may be included in lead collectors (the same or different) presented on different web pages of the same website.

The method of FIG. 5 may be implemented by the systems described, for example, by server 102 implementing system 103, and/or integrated (entirely or partially) with the methods described herein (e.g., FIG. 3A-3B and/or 4).

At 502, web pages of a web site hosted by a web server are identified. The web site includes the web pages, for example, the web pages share a common domain name system (DNS), a common host name, a common root URL, and/or defined as members of the web page by a summary page and/or in a table.

The web site may be designated as being identified with a registered member and/or subscriber of the lead generation service provided by the server, for example, the web site may be operated by an online business such as an online store selling items, an online travel agency, and/or an advertiser and/or marketer (e.g., online advertiser and/or online marketer). The web site may be designated by the server, for example, based on results of a search engine, based on a predefine list of web sites, and/or based on a link from another web site.

Optionally, the web site (e.g., registered member) has installed thereon code (e.g., a script, an API, and/or other executable code) at one or more web pages, for example, installed manually and/or automatically as described herein. The code may be installed centrally on the web server, at the web site, and/or within one or more web pages, such as per page and/or for a group of pages.

Optionally, the identifying is performed by an automated network (e.g., internet) crawling program that crawls web pages of the web site. The crawling program may follow links within the web site, to identify the member web pages of the web site. The crawling program may crawl the web site, for example, at predefined intervals which may be regular (e.g., once a month), randomly, according to availability of resources (e.g., processor, storage, network bandwidth), and/or triggered by an event. The crawling program identifies new web pages added to the web site, new web sites, and/or new content on known web pages. The updates identified by the crawling program may be used to generate up to date lead collectors using the methods described herein. For example, lead collectors may be generated based on the real-time news item presented on a news web site, and/or the most recent post on a blog.

At 504, each identified web page of the web site is indexed according to an assigned index value. The web pages may be indexed in an index database, for example locally stored and/or in communication with the server, for example, stored on storage 231 of system 103 and/or server 102. The index value may be, for example, the URL of the web page. Each web page may be represented as a record, which may be assigned a unique identification (ID) label. In this manner, each web page of the web site is mapped to a record in the database.

At 506, each record (representing a web page of the web site) is associated with one or more lead parameters, for example, stored as fields within each record. The lead parameters are generated based on an analysis of web page data and/or user data, and/or data automatically extracted from the respective identified web page. The lead parameters may be generated based on the methods described herein, for example, based on data collected by web page data collector 132 and/or lead collector 134, and/or analyzed by module 222. Other methods may be used to generate lead parameters, for example, identification of key words on the web site, identification of a headline, and/or other classification and/or analysis methods.

Optionally, the lead parameter includes an advertising vertical category, advertising vertical sub-category, topics of content, and/or topics being discussed. Examples of lead parameters include vacations, medical tourism, law services, and loans. Lead parameters may include other data collected and/or processed using the methods and/or systems described herein, for example, as described with reference to block 302 of FIG. 3.

Alternatively or additionally, the lead parameters include one or more other values and/or parameters calculated using other methods described herein, for example, as determined by module 222.

Optionally, each web page is analyzed independently, such as according to the content of the respective web page. The lead parameters may be independently determined for each web page.

Alternatively or additionally, the lead parameters are determined based on an analysis of multiple web pages associated with the web site. The lead parameters may be determined for a group of web pages, which may share common content, a common theme, a common author, a common category (e.g., relate to the same concept), and/or other commonalities. The lead parameters for the group of web pages may be common to all or some members of the group. Examples of lead parameters determined for a group of web pages include: a name of the business operating using the web site, a logo of the business operating using the web site, and colors of the business operating using the web site.

At 508, an index value is received by the server. The index value corresponds to a web page of the web site being accessed by a user of a client terminal (e.g., using a browser), for example, the URL of the web page. The index value may be transmitted by the web server and/or the client terminal.

At 510, the database is accessed using the received index value, to retrieve the associated lead parameter(s).

A lack of a match of the web page being accessed by the user with a record in the database represents a new web page that has not yet been indexed. Optionally, the new web page may be processed using the system and/or methods described herein, for example, as discussed with reference to FIG. 3. Alternatively, the web page may be indexed and processed in real time using one or more of blocks 502-506.

At 512, a lead collector is selected (e.g., from a set of pre-generated lead parameters stored in a storage device, in a database and/or data repository) and/or dynamically generated, for example, using methods described herein with reference to block 304 of FIG. 3.

Different lead collectors may be selected and/or generated independently for each page. Alternatively or additionally, a common lead collector is selected and/or generated for a group of web pages, optionally for the entire web site, or for different groups of the web site (e.g., per category, topic, or other classification).

Different lead collected may be selected and/or generated for different users accessing the same web page, for example, each user may receive a customized lead collector, for example, based on an analysis of user data described herein. Alternatively or additionally, a common lead collector may be selected and/or generated for a group of users, for example, users from a certain city may view a common lead collector, and/or users using a keyboard with a certain language may view a common lead collector.

The lead collector may be dynamically selected and/or generated in view of real-time content displayed on the web site. For example, web pages having content that is updated regularly, for example, news sites with new news stories, blogs with new blog entries, and online stores with new specials.

The selector and/or dynamic generation of the lead collector may be based on a combination of the above, for example, simultaneously and/or iteratively. For example, the lead parameter may be used as a guide to a group of lead collectors, and/or to a certain lead collector template. The actual lead collector and/or the way the template is filled may be dynamically based on the actual user and/or real-time content.

At 514, the selected and/or generated lead collector is transmitted to the web server, for presentation to the user on the web page, as described herein. It is noted that the same lead collector may follow the user during navigation of different pages on the web site (e.g., when a common lead collector has been selected and/or generated), and/or the lead collector may be changed to another lead collector as the user navigates web pages on the web site (e.g., when different lead collectors have been selected and/or generated).

It is noted that the method may continue using other methods and/or systems described herein, for example, as described with reference to block 308 of FIG. 3. Optionally, when the web server is associated with a registered subscriber to the lead generation service, the leads obtained from the transmitted lead collectors are exclusively forwarded to the web server, or to another designated server, such as a CRM associated with the registered user. In this manner, the registered user exclusively receives the leads generated from its own web site using the lead collectors provided by the server.

The methods as described above are used in the fabrication of integrated circuit chips.

The flowchart and block diagrams in the Figures illustrate the architecture, functionality, and operation of possible implementations of systems, methods and computer program products according to various embodiments of the present invention.

In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant codes and code segments will be developed and the scope of the terms leads and lead collectors are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method executed by at least one server for automatically generating leads for information providing, over a network, comprising:
using at least one server, said at least one server including at least one processor in communication over a network with at least one web server, and with a storage device storing program code for implementation by said processor, to perform the following:
generating a lead collector code executable for creating a user interface for collecting user inputs from a user at a web page of a web site hosted by a web server, said user interface having at least one of a design and a media content selected based on an analysis of web page data automatically extracted from said web page;
adding said lead collector code to said web page at said web server so as to trigger the presentation of said user interface when said web page is presented by a browser executed on a client terminal; wherein said lead collector code is executed to obtain user inputs manually inputted by said user using a physical interface to said user interface when said browser presents said user interface;
receiving said obtained user inputs at said at least one server from said client terminal or said web server;
processing said obtained user inputs at said at least one server to generate at least one lead from said obtained data; and
forwarding said at least one lead to an information provider.

2. The method of claim 1, wherein said web page data includes information selected from the group consisting of a textual content of said web page, a language of textual content of said web page, a hierarchical location of said webpage in said website, a theme of said web page, a design of said web page, links to web pages in said web page, and web sites linking to said web page.

3. The method of claim 2, wherein said web page data is obtained by a web page data collector integrated into a code of said website.

4. The method of claim 2, wherein said generating comprises identifying a profile of said user when said browser requests accessing said webpage; wherein said user interface having at least one of a design and a media content selected according to an analysis of said profile.

5. The method of claim 4, wherein said profile comprises a member of a group consisting of: an address of said client terminal, a domain of a server associate with said client terminal, an e-mail address of said user, at least one advertisement with which said user has been presented, an operating system (OS) of said client terminal, a Language of a keyboard of said client terminal, a Language of said OS of said client terminal, at least one keyword in a query submitted before said browser requests accessing said webpage, a content of said webpage currently highlighted based on a user input, an address of a previous webpage accessed before said browser requests accessing said webpage.

6. (canceled)

7. The method of claim 1, wherein said profile is obtained by at least one of: monitoring previous data inputs of said user using said browser and by a web page data collector integrated into a code of said website.

8. The method of claim 4, wherein said forwarding comprises additionally comprising calculating a score for said at least one lead for quality based on a match of at least one of said profile, said web page data, and said obtained user inputs and data defining said information provider.

9. (canceled)

10. The method of claim 1, wherein said user interface comprises an instant messaging (IM) interface for allowing said user to communicate with said information provider by inputting and receiving IM messages; wherein said forwarding said at least one lead to an information provider comprises adding an agent of said information provider to an IM session managed by said IM interface.

11. The method of claim 1, further comprising:
identifying web pages of s web site hosted by at least one web server;
indexing, in a database, each identified web page of said web site according to an assigned index value;
associating, in said database, each identified web page of said web site with at least one lead parameter based on an analysis of web page data automatically extracted from said respective identified web page;
receiving, from at least one of said at least one web server and a client terminal of a user accessing a certain web page of said website, a certain index value corresponding to said accessed certain web page;
accessing said database using said certain index value to retrieve said associated at least one lead parameter.

12-14. (canceled)

15. The method of claim 1, wherein said forwarding comprises receiving a plurality of bids from a plurality of information providers for said at least one lead and selecting said information provider based on an analysis of said plurality of bids.

16. The method of claim 1, further comprising:
indexing, in a database, each web page of said web site hosted by said web server, according to an assigned index value;
associating, in said database, each web page of said web site with at least one lead parameter including at least an advertising vertical category based on an analysis of data related to said web page;
receiving, from at least one of said web server and said client terminal of said user accessing a certain web page of said website, a certain index value corresponding to said accessed certain web page;
accessing said database using said certain index value to retrieve said associated at least one lead parameter; and
wherein said generating said lead collector code is executed according to said associated at least one parameter.

17. The method of claim 16, further comprising identifying said web pages by an automated network crawling program that crawls web pages of said web site.

18. The method of claim 17, wherein said automated network crawling program repeats crawling of web pages of said web site to at least one of identify new web pages and identify new content on existing web pages.

19. The method of claim 16, wherein said at least one lead parameter includes a member selected from the group consisting of:
advertising vertical sub-category, a topic of discussion, a content topic, a name of the business operating using the web site, a logo of the business operating using the web site, and colors of the business operating using the web site.

20-22. (canceled)

23. The method of claim 16, wherein said lead collector code is dynamically generated according to at least one of said user accessing said certain web page and content currently displayed on said web page.

24. The method of claim 1, further comprising:
identifying said web server as a registered subscriber with said at least one server, and wherein forwarding said at least one lead to said information provider comprises forwarding said at least one lead to at least one of said web server, and a customer relationship management (CRM) system associated with said web server.

25. A computer system for generating leads for information providing, over a network, comprising:
an input interface for receiving from a lead collector code, via a network, obtained user inputs from a client terminal or a web server;
a program store storing code; and
a processor coupled to said input interface, and to said program store for implementing said stored code, said code comprising:
code to generate said lead collector code, said lead collector code is executable for creating a user interface for collecting user inputs via a physical interface from a user at a web page of a web site hosted by a web server, said user interface having at least one of a design and a media content selected based on an analysis of web page data automatically extracted from said web page;
code to transmit said lead collector code for adding to said web page at said web server so as to trigger the presentation of said user interface when said web page is presented by a browser executed on a client terminal;
wherein said lead collector code is executed for obtaining user inputs manually inputted by said user to said user interface when said browser presents said user interface;
code to analyze said obtained user inputs to generate at least one lead from said obtained data; and
code to forward said at least one lead to an information provider.

26. (canceled)

27. The system of claim 25, further comprising code to tag said at least one lead with at least one tag for identification of said at least one lead and code to score said at least one lead for quality based said on at least one tag of said at least one lead and code to price said at least one lead based on said score.

28. A computer usable non-transitory storage medium having a computer program embodied thereon for causing a suitable programmed system to generate leads for information providing, by performing the following steps when such program is executed on the system, comprising:
generating a lead collector code executable for creating a user interface for collecting user inputs from a user at a web page of a web site hosted by a web server, said user interface having at least one of a design and a media content selected based on an analysis of web page data automatically extracted from said web page;
adding said lead collector code to said web page at said web server so as to trigger the presentation of said user interface when said web page is presented by a browser executed on a client terminal;
obtaining user inputs manually inputted by said user to said user interface when said browser presents said user interface;
receiving said obtained user inputs from said client terminal or said web server;
processing said obtained user inputs to generate at least one lead from said obtained data; and
forwarding said at least one lead to an information provider.

29. The computer usable non-transitory storage medium of claim 28, wherein said user interface is a graphical user interface (GUI) having an instant messaging interface for facilitating said user to input chat messages while discussing with an agent of said information provider.

30. (canceled)
